(19) United States
(12) Patent Application Publication
(10) Pub. No.: US 2007/0250300 A1
(43) Pub. Date: Oct. 25, 2007

(54) Method for Controlling a Microbiological Process on the Basis of Successive Temporal Derivatives of State Variables

(75) Inventors: Antoine Genovesi, Gif-Sur-Yvette (FR); Quang-Khai Tran, Villiers Sur Marne (FR)

Correspondence Address: YOUNG & THOMPSON, 745 SOUTH 23RD STREET, 2ND FLOOR, ARLINGTON, VA, 22202, US

(73) Assignee: COMPAGNIE GERVAIS DANONE, Paris (FR)

(21) Appl. No.: 11/628,161

(22) PCT Filed: May 23, 2005
(86) PCT No.: PCT/FR05/01275

§ 371 Date: Nov. 30, 2006

(30) Foreign Application Priority Data
Jun. 2, 2004 (FR) 0405971

(51) Int. Cl. G06G 7/48

(52) U.S. Cl. 703/11

(57) ABSTRACT

The invention relates to a method for controlling microbiological process in a liquid microbial population-containing medium consisting in on-line measuring at least one state variable related to the microbiological process and in utilising at each instant (t) values measured for at least one state variable by calculating therefrom the first, second and third temporal derivatives after smoothing values over a time period adjustable by a causal mathematical filter after each measurement and each temporal derivative calculation. One or several calculated and smoothed values of the state variable are compared at each instant (t) with at least one predefined criterion in order to identify the microbiological process phases and to determine the necessity for producing an action thereon.

The present invention relates in a general manner to methods of control of microbiological processes, and more precisely to a method of tracking the evolution of state variables and of their successive time derivatives so as to characterize the various phases of the microbiological process.

The major preoccupation of food industries is the overseeing of the key steps of the biological or chemical reactions in a liquid medium (lactic bacterial fermentations, production of acid, etc.).

The knowledge of these steps makes it possible to understand (application in research) and control the processes (industrial applications) implementing these microbiological processes.

Insufficient characterization of these steps may give rise to uncertainties as to the quality, for example, of the bacteria used in the lactic fermentations. Nowadays, specifications based on the quality of the bacteria, their microbiological purity, their population are being imposed by the food industry on their suppliers of ferments. However, the processes used in a standard manner generally employ monitoring criteria based on raw, and hence very noisy, measured values such as for example the volume of basic solution added to the fermenter. In particular, the determination of the fermentation stoppage conditions is not very accurate, thus giving rise to uncertainties regarding the quality of the bacteria produced. These uncertainties may give rise, during the use of these ferments, to variations of several hours from one fermenter to another over the duration of the microbiological processes.

Enhanced characterization allowing accurate and reproducible knowledge of the specific fermentation stoppage conditions, and the triggering of the necessary actions, would allow an improvement and a standardization of the quality of the lactic bacteria obtained.

In a general manner, the command of microbiological processes by the on-line tracking of the signals of measurement instruments may prove to be tricky, since the raw values of these signals are too noisy to allow direct utilization.

The aim of the present invention is to propose a method allowing improved on-line tracking, in real time, of a microbiological process in a liquid medium, and a better knowledge of the biological and chemical reactions in this medium during the key steps of the process.

For this purpose, the present invention relates to a method of controlling a microbiological process in a liquid medium. In this process at least one state variable relating to the microbiological process is measured continuously, and at each instant t the values measured for at least one state variable are utilized according to the following steps:
smoothing the measured values of the state variable over a first adjustable time interval preceding the instant t on the basis of a first causal filter, to obtain a smoothed value of the state variable at the instant t,
calculating the speed of variation of the state variable at the instant t on the basis of the smoothed values of the state variable,
smoothing the calculated values of the speed of variation over a second adjustable time interval preceding the instant t on the basis of a second causal filter, to obtain a smoothed value of the speed of variation of the state variable at the instant t,
calculating the acceleration of variation of the state variable at the instant t on the basis of the smoothed values of the speed of variation, and
smoothing the calculated values of the acceleration of variation over a third adjustable time interval preceding the instant t on the basis of a third causal filter, to obtain a smoothed value of the acceleration of variation of the state variable at the instant t,
comparing the smoothed value of the speed and/or of the acceleration of the state variable with at least one predefined criterion so as to identify phases of the microbiological process and to determine whether an action on this process is necessary.

Thus the smoothing of the measured and calculated data allows, once the noise has been eliminated, the improved tracking of the first and second time derivatives of the state variables, which are then relevant or irrelevant for triggering an action on the process. A criterion based on a maximum of speed of a parameter becomes for example a vanishing and a change of sign on the acceleration of this same parameter.

Moreover, the use of causal filters allows real-time tracking of the evolution of the parameters, without the phase shift related to non causal filters which require values measured after the instant t.

In a preferred embodiment, the method also comprises the following steps:
calculating the rate of variation of the acceleration of variation of the state variable at the instant t on the basis of the smoothed values of the acceleration of variation, and
smoothing the calculated values of the rate of variation of the acceleration of variation over a fourth adjustable time interval preceding the instant t on the basis of a fourth causal filter, to obtain a smoothed value of the rate of variation of the acceleration of variation of the state variable at the instant t,
   when the defined criterion is dependent on said rate of variation of the acceleration of variation.

Thus, the successive smoothings make it possible to calculate up to the third time derivative of a state variable and to have smoothed data relevant for the tracking of the process.

In another embodiment, the smoothed values calculated at the instant t and the preceding instant are used for the calculation of the derivatives by dividing their variation by the time interval between two values.

In an additional embodiment, the causal filters may be a least squares filter, a rectangular-means filter, or a first order exponential filter.

In an advantageous embodiment, the value of the first, second, third and fourth adjustable time intervals is an identical value for the four successive smoothings.

The invention also relates to a computer program product, to be executed in a processing unit of a computer system, comprising instructions for the implementation of the method above during its execution in the processing unit.

Other characteristics and advantages of the invention will appear further on reading the description which follows. The latter is purely illustrative and should be read in conjunction with the appended drawings in which:

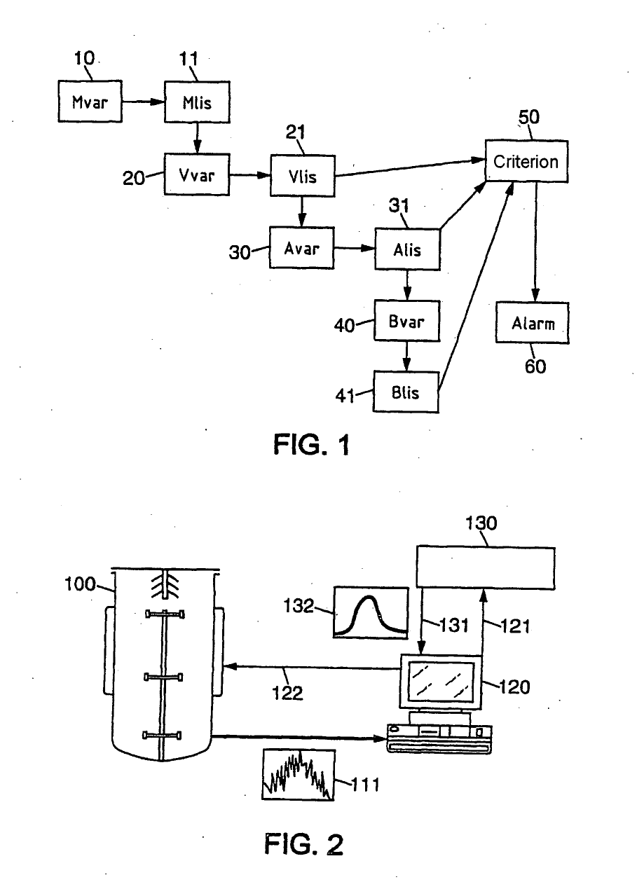

FIG. 1 is a schematic diagram illustrating the principle of smoothing and of calculation of the successive derivatives of a state variable implemented in the method according to the invention,

FIG. 2 is a diagrammatic representation of a fermentation reactor, of the electronic processing unit and of the supervisor module for the implementation of the method according to the invention, and,

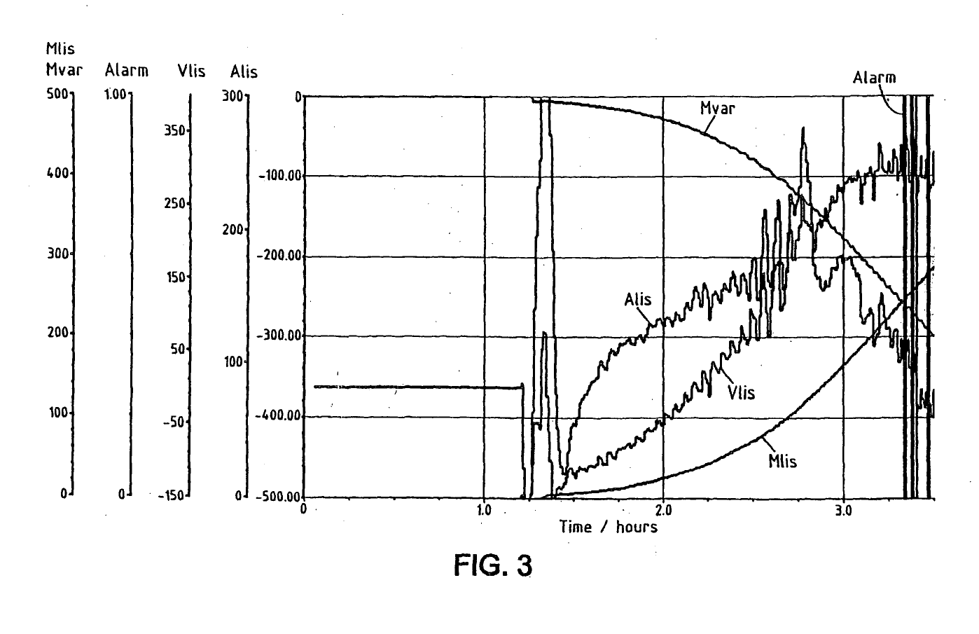

FIG. 3 illustrates the successive smoothings and an exemplary criterion on the acceleration for the implementation of the method according to the invention.

In the method according to the invention, at least one state variable characteristic of the microbiological process is measured continuously, and the measured values, or signals, are utilized at each acquisition instant t, for one or more state variables according to the processing set forth hereinafter.

FIG. 1 illustrates, in schematic form, the processing, in the sense of the invention, of the signals acquired continuously by various sensors allowing the measurement of state variables of a microbiological process in progress. For the sake of simplification, the processing is illustrated for the signals of a single sensor measuring a single state variable, but may be extended to several sensors allowing the tracking of a set of state variables. This processing is implemented during each acquisition of a new signal of a sensor.

Step 10 corresponds to the acquisition of the new signal Mvar of the sensor at an instant t. The set of measured signals is generally very noisy. The direct calculation of the speed of variation on the basis of such signals would give rise to abrupt variations in the speed, rendering it hardly relevant and unusable for the tracking of the process.

In order to improve the tracking of the state variable, a first smoothing of the noisy data Mvar is provided in step 11 of the processing, at each acquisition of a new value of the signal. This smoothing is carried out by way of a causal mathematical filter, that is to say it uses only the signals already acquired from the state variable. The result of the filtering is therefore known practically at the same time as the acquisition of the new signal, to within the filtering time.

Moreover, a first time interval Pt1 is defined so as to limit the application of the causal filter to a time interval preceding the instant t of the last acquisition. This time interval Pt1 is a parameter of the method. The smoothing of the values over the interval [t−Pt1, t] makes it possible to obtain the noise-free variations of the state variable over this time interval preceding the instant t. This smoothing yields the noise-free value Mlis of the state variable at the instant t. The time interval Pt1 is adjustable and its choice is a compromise between the filtering calculation time (increasing as a function of Pt1), and the need to acquire a sufficient number of signals to ensure good tracking of the variations of the state variable. When the process starts up, the smoothing begins when the number of acquisitions corresponding to the interval Pt1 is obtained. The compromise also comprises the delay induced by the consideration of an overly long time horizon.

The whole set of steps 11 for the entire duration of the microbiological process thus makes it possible to reconstruct a curve of smoothed values Mlis of the state variable.

During step 20 of the processing, the speed of variation Vvar of the state variable is calculated on the basis of the smoothed values Mlis of the state variable. It is possible to envisage several modes of calculating the speed involving a greater or lesser number of smoothed values Mlis at the instants preceding the instant t. In a preferred mode of implementation of the method, the speed of variation Vvar is calculated at the instant t according to the following formula;

$$Vvar = \frac{ⅆ Mlis}{ⅆ t} \qquad ( 1 )$$

in which dmlis is the variation of the smoothed value of the state variable between the instant t and the preceding instant, and dt the time interval between these two instants.

The whole set of steps 20 for the entire duration of the process thus makes it possible to determine the speed of variation Vvar of the state variable at each instant t.

The time derivative may give rise to oscillations comparable to the noise noted on the signals of a sensor. These oscillations may hamper the tracking of the process, especially upon the application of a stoppage criterion based on the speed of variation of a state variable. So, during an additional step 21 of the processing, a smoothing of the calculated speeds Vvar for each new calculated value of the speed is performed. This smoothing is carried out on the basis of a second causal mathematical filter, over a second time interval Pt2, other parameter of the method. In a preferred embodiment, the time intervals Pt1 and Pt2 are chosen to be identical to a common value Pt, in such a way that the second smoothing is carried out over the same time interval [t−Pt, t] as the smoothing of the noisy data Mvar. One thus obtains smoothed values of the speed of variation of the state variable over this time interval preceding the instant t. This smoothing yields the smoothed value Vlis of the speed of variation of the state variable at the instant t.

The whole set of steps 21 for the entire duration of the microbiological process thus makes it possible to determine the smoothed values Vlis of the speed of variation Vvar of the state variable at each instant t.

A process tracking criterion based on a maximum speed of variation of a state variable would amount to looking to see whether the acceleration of variation of this same state variable vanishes and changes sign.

So, during step 30 of the processing, the acceleration of variation Avar of the state variable is calculated on the basis of the smoothed values Vlis of the speed of variation of the state variable. It is possible to envisage several modes of calculating the acceleration involving a greater or lesser number of smoothed values Vlis at the instants preceding the instant t. In a preferred mode of implementation of the method, the acceleration of variation Avar is calculated at the instant t according to the following formula:

$$Avar = \frac{ⅆ Vlis}{ⅆ t} \qquad ( 2 )$$

in which dvlis is the variation of the smoothed value of the speed of variation of the state variable between the instant t and the preceding instant, and dt the time interval between the two instants.

The whole set of steps 30 for the entire duration of the microbiological process thus makes it possible to determine the acceleration of variation Avar of the state variable at each instant t.

This new time derivation may give rise to oscillations comparable to the noise noted on the signals of a sensor. Moreover, it is possible to envisage, for certain state variables, microbiological process tracking criteria based on extremal values of the acceleration. In an additional mode of implementation of the method according to the invention, a smoothing of the accelerations calculated Avar is applied for each new calculated value of the acceleration, during an additional step 31 of the processing. This smoothing is carried out on the basis of a third causal mathematical filter, over a third time interval Pt3, other parameter of the method. In a preferred embodiment, the time intervals Pt1, Pt2 and Pt3 are chosen to be identical to a common value Pt, in such a way that the third smoothing is carried out over the same time interval [t−Pt, t] as the smoothing of the noisy data Mvar or of the speed of variation Vvar. One thus obtains smoothed values of the acceleration of variation of the state variable over this time interval preceding the instant t. This smoothing yields the smoothed value Alis of the acceleration of variation of the state variable at the instant t.

The whole set of steps 31 for the entire duration of the microbiological process thus makes it possible to determine the smoothed values Alis of the acceleration of variation of the state variable at each instant t.

In an additional embodiment of the method according to the invention, it may be beneficial to calculate the rate of variation of the acceleration of variation of the state variable (or third time derivative) at each instant t, when the criterion defined is dependent on this rate of variation. During step 40 of the processing, the rate of variation Bvar of the acceleration of variation of the state variable is calculated on the basis of the smoothed values Alis of the acceleration of the state variable. It is possible to envisage several modes of calculating this rate, involving a greater or lesser number of smoothed values Alis at the instants preceding the instant t. In a preferred mode of implementation of the method, the rate of variation of the acceleration Bvar at the instant t is calculated according to the following formula:

$$Bvar = \frac{ⅆ Alis}{ⅆ t} \qquad ( 3 )$$

in which dAlis is the variation of the smoothed value of the acceleration of variation of the state variable between the instant t and the preceding instant, and dt the time interval between the two instants.

The whole set of steps 40 for the entire duration of the microbiological process thus makes it possible to determine the rate of variation Bvar of the acceleration of variation of the state variable at each instant t.

In order to limit the noise of the calculated values Bvar, a smoothing of the calculated rates of variation of the acceleration Bvar is applied, during an additional step 41 of the processing, for each new calculated value of these rates. This smoothing is carried out on the basis of a fourth causal mathematical filter, over a fourth time interval Pt4, other parameter of the method. In a preferred embodiment, the time intervals Pt1, Pt2, Pt3 and Pt4 are chosen to be identical to a common value Pt, in such a way that the fourth smoothing is carried out over the same time interval [t−Pt, t] as the smoothing of the noisy data Mvar, of the speed of variation Vvar or of the acceleration of variation Avar. One thus obtains smoothed values of this rate of variation of the acceleration of the state variable over this time interval preceding the instant t. This smoothing yields the smoothed value Blis of the rate of variation of the acceleration of the state variable at the instant t.

As a function of the state variable tracked, it is possible to envisage various types of criteria making it possible to quantify the degree of advancement and/or the state of the microbiological process. In an additional step 50 of the processing presented in FIG. 1, one or more of the various values calculated Vlis, Alis and Blis is (are) compared with a respective criterion, to determine whether the criterion is or is not fulfilled. The criteria making it possible to characterize the state of the microbiological process may be simple (maximum speed, maximum acceleration, vanishing of the speed or of the acceleration), and may involve just one state variable. It is also possible to envisage more complex criteria involving several state variables. The criterion may also require the use of a value at the instant t and of one or more values at the preceding instants. Such is the case for example when the criterion pertains to a speed maximum. It then amounts to a criterion of passing through a zero value and a change of sign of the smoothed acceleration Alis. In all cases of interest, when the criterion is fulfilled, an alarm is raised in a last step 60.

The processing set forth above therefore allows the calculation, at each instant t of acquisition of the signals, of the first Vlis, second Alis and third Blis derivatives of a state variable.

The successive smoothings allow the attenuation of the noise related to the sensors, to the dead bands and to the various successive calculations of derivatives. The application of predefined criteria, so as to identify phases of the microbiological process and to determine whether an action on the process is necessary, is thus facilitated. The various causal mathematical filters used are filters commonly used by the person skilled in the art in the processing of the sensor signal to eliminate noise, such as a least squares filter, a rectangular-means filter, or a first order exponential filter. It is also possible to envisage combining certain of these filters so as to obtain a more robust filtering. For example, the smoothed values over the interval [t−Pt, t] are then the result of the arithmetic mean of the values resulting from a least squares filter with the values resulting from a rectangular-means filter over this same interval.

The benefit of a causal mathematical filter is that it allows the method according to the invention to be usable in real time. A non causal filter would require the knowledge of additional values of signals, after the instant t, and this would give rise to an offset in time for the calculation of the successive derivatives and the application of the associated criteria.

FIG. 2 illustrates a fermentation reactor 100, in which a microbiological process, such as a fermentation reaction for example, is running. Various sensors (not represented in the figure), or acquisition devices, allow the real-time and continuous tracking of state variables characteristic of the microbiological process in progress. A supervisor module 120, furnished with an internal clock, allows the acquisition by the sensors of the signals 111 which are transmitted to it. The supervisor module 120 may be a microcomputer for example, and allows the command of the reaction in progress by way of an automaton (not represented) linked to the reactor. It is adapted in particular for allowing the acquisition at regular or irregular intervals of the signals of the sensors as a function of the instructions of a user.

These signals 111, generally very noisy, do not allow their direct utilization. In this regard, an electronic processing unit 130 is provided so as to implement the method according to the invention. The supervisor module 120 transmits, for each new acquisition, the signals of the various sensors 111 and the acquisition instant t to the electronic processing unit 130, via a link 121. This unit 130 may or may not be included in the supervisor module 120.

The processing unit is programmed appropriately to apply the method of processing within the sense of the invention to the signals 111 acquired by the sensor or sensors of the reactor 100. The electronic processing unit performs at each instant t the smoothings as well as the calculations of the various values detailed previously. In this regard, it comprises means of calculation for the implementation of the various causal mathematical filters and the calculation of the derived values, and possibly means of storage for recording the various calculated and smoothed values. Moreover, this processing unit also comprises a memory, or a removable memory medium intended to cooperate with a reader of the processing unit, suitable for storing a computer program comprising instructions for the implementation of all or part of the steps of the method described hereinabove.

The processing unit can comprise means of interfacing with the operator, common or otherwise to those of the supervisor module 120. The interfacing means may in particular allow the operator to input, by way of an enquiry window displayed on a screen for example, the variables that he wishes to monitor, the associated criteria pertaining to the first, second and/or third derivative, as well as the time interval over which the smoothing by the causal mathematical filters is to be applied. It is also possible to envisage the case where several reactors are addressable, the interfacing means then allow the operator to select one or more reactors for which he wishes to implement the method according to the invention.

The processing unit 130 also compares at each instant t of acquisition, the various values calculated Vlis, Alis and Blis with criteria defined by the operator, and raises an alarm, by allocating it a particular value for example, when a criterion is fulfilled. It thereafter transmits the calculated and smoothed values Mlis, Vlis, Alis and Blis (label 132 of FIG. 2), the state of the alarm, as well as the instant t to the supervisor module 120. It can also transmit the values Vvar, Avar and Bvar. The supervisor module is able on the one hand to display the values received from the processing unit 130, as well as the various criteria defined and the state of the alarm. Moreover, the supervisor module is able to send a specific command order 122 to an automaton (not represented in FIG. 2), which order is dependent on the criterion fulfilled. The automaton then commands the reactor as a function of the order received by triggering an appropriate action (stoppage of the reaction, addition of an additive, etc).

Various state variables may thus be monitored by virtue of the method according to the invention. By way of example, it is possible to cite the temperature of the liquid medium, its pH, the quantity of biomass, the addition of a basic solution to the liquid medium, etc.

One of the principal state variables in a fermentation method is the evolution of the concentration of the biomass in the reactor, that is to say the rate of growth of the microbial cells, in particular bacteria or yeasts in the fermenter. Various techniques exist for tracking the concentration of the biomass, such as the use of optical probes which measure the turbidity or the transmission of light and/or the scattering of light through the cellular suspensions of the liquid medium. Capacitive probes have been developed which make it possible to measure the capacitance of suspension of cells subjected to low radiofrequencies (0.1 MHz to 10 MHz) which is a function of the volume of the viable cells. Probes of this type may be inserted into a reactor and allow on-line measurement of the quantity of biomass.

The principle of measuring the quantity of biomass is based on the passive dielectric properties of biological cells, in particular of lactic bacteria. Thus, under the influence of an electric field, the cell membranes polarize like the surfaces of an electric capacitor. The positive ions go toward the negative electrode and the negative ions go toward the positive electrode. The accumulation of these charges may be quantified by measuring the capacitance of the suspension. The larger the quantity of charges accumulated, the bigger the quantity of biomass present; the measurement of capacitance can thus be linked directly to the measurement of biomass.

Another interesting variable is the electrical conductivity, which gives information about the ionic composition of the medium, since the transport of the current in solutions is ensured solely by the ions.

FIG. 3 presents an exemplary tracking of the fermentation of lactic bacteria. It is the determination of the moment of stoppage of the fermentation which is sought-after. The method according to the invention makes it possible to determine the moment of maximum activity of the lactic bacteria as a function of an acidification criterion. The consumption of basic solution is the variable tracked in this example and is measured by way of the balance signal (weight indicator) which makes it possible to measure a volume of basic solution necessary for neutralizing the lactic acid produced by the growing bacteria. Based on the measurement of the balance in real time, the processing unit calculates the speed and the acceleration of this state variable. In order to highlight the significant behaviors of the phases of the fermentation, and in view of the fact that the signal measured is too noisy to allow its direct utilization for the control of the method, the processing unit performs the smoothings and the calculations of successive time derivatives as presented above. In this specific example, only the smoothed values of the speed and of the acceleration of the consumption of basic solution are necessary.

The tracking criterion allowing the determination of the moment of stoppage of the fermentation has been determined experimentally, and corresponds to the maximum speed of addition of basic solution. The corresponding acceleration becomes zero and changes sign.

FIG. 3 corresponds to a possible visualization of the tracking of the above microbiological process on the basis of the supervisor module. The noisy balance signal (Mvar in the figure), the smoothed signal (Mlis in the figure, represented by its absolute value), the value of the filtered speed of variation (Vlis), the value of the filtered acceleration (Alis), as well as the criterion (value of the zero acceleration, represented by the alarm parameter) are retrieved. When the alarm is raised once the criterion is fulfilled, the supervisor module transmits an order to the automaton commanding the reactor to lower the fermentation temperature so as to stop the process.

The accurate and reproducible knowledge of the moment at which this specific stoppage criterion is fulfilled, as well as the triggering of the actions stemming therefrom, allows an improvement and a standardization of the quality of the lactic bacteria obtained.

1. A method of controlling a microbiological process in a liquid medium, and characterized in that it consists in measuring on-line at least one state variable relating to said microbiological process, and in utilizing at each instant (t) the values measured for at least one state variable according to the following steps:
smoothing the measured values (Mvar) of said state variable over a first adjustable time interval (Pt1) preceding said instant (t) on the basis of a first causal filter, to obtain a smoothed value (Mlis) of the state variable at the instant (t),
calculating the speed of variation (Vvar) of said state variable at the instant t on the basis of said smoothed values of said state variable,
smoothing the calculated values of said speed of variation over a second adjustable time interval (Pt2) preceding said instant (t) on the basis of a second causal filter, to obtain a smoothed value (Vlis) of the speed of variation of the state variable at the instant (t),
calculating the acceleration of variation (Avar) of said state variable at the instant (t) on the basis of said smoothed values of the speed of variation, and
smoothing the calculated values of said acceleration of variation over a third adjustable time interval (Pt3) preceding said instant (t) on the basis of a third causal filter, to obtain a smoothed value (Alis) of the acceleration of variation of the state variable at the instant (t),
comparing the smoothed value of the speed and/or of the acceleration of said state variable with at least one predefined criterion so as to identify phases of the microbiological process and to determine whether an action on said process is necessary.

2. The method of control as claimed claim 1, comprising the following additional steps:
calculating the rate of variation (Bvar) of the acceleration of variation of the state variable at the instant (t) on the basis of said smoothed values of the acceleration of variation, and
smoothing the calculated values of said rate of variation of the acceleration of variation over a fourth adjustable time interval (Pt4) preceding said instant (t) on the basis of a fourth causal filter, to obtain a smoothed value (Blis) of the rate of variation of the acceleration of variation of the state variable at the instant (t),
when the defined criterion is dependent on said rate of variation of the acceleration of variation.

3. The method of control as claimed in claim 1, in which the calculation of the speed (Vvar) of variation of the state variable at the instant (t) is performed according to the following formula:
$$Vvar = \frac{ⅆ Mlis}{ⅆ t}$$
in which dmlis is the variation of the smoothed value of said state variable between the instant (t) and the preceding instant, and dt the time interval between the two instants.

4. The method of control as claimed in claim 1, in which the calculation of the acceleration (Avar) of variation of the state variable at the instant (t) is performed according to the following formula:
$$Avar = \frac{ⅆ Vlis}{ⅆ t}$$
in which dvlis is the variation of the smoothed value of the speed of variation of said state variable between the instant (t) and the preceding instant, and dt the time interval between the two instants.

5. The method of control as claimed in claim 2, in which the calculation of the speed of variation of the acceleration (Bvar) at the instant (t) is performed according to the following formula:
$$Bvar = \frac{ⅆ Alis}{ⅆ t}$$
in which dalis is the variation of the smoothed value of the acceleration of variation of the state variable between the instant (t) and the preceding instant, and dt the time interval between the two instants.

6. The method of control as claimed in claim 1, in which the first, second, third and fourth adjustable time intervals have an identical value (Pt).

7. The method of control as claimed in claim 1, in which the smoothing of the measured values and of the calculated values is performed by an electronic processing unit (130).

8. The method of control as claimed in claim 1, in which the microbiological process is carried out in a fermentation reactor (100) comprising acquisition devices able to deliver the measured values of at least one state variable of said microbiological process to a supervisor module (120), said supervisor module being able to send command orders (122) to said fermentation reactor by way of an automaton capable of commanding said microbiological process.

9. Method of control as claimed in claim 8, in which the measured values as well as the measurement instants are transmitted to the electronic processing unit by the supervisor module.

10. The method of control as claimed in claim 1, in which an alarm is raised by the calculation unit when the predefined criterion is fulfilled, and is transmitted to the microbiological process supervisor module, said supervisor module transmitting a specific command order to the automaton when the alarm is raised.

11. The method of control as claimed in claim 1, in which the first causal filter is a least squares filter, or a rectangular-means filter, or a first order exponential filter.

12. The method of control as claimed in claim 1, in which the second causal filter is a least squares filter, or a rectangular-means filter, or a first order exponential filter.

13. The method of control as claimed in claim 1, in which the third causal filter is a least squares filter, or a rectangular-means filter, or a first order exponential filter.

14. The method of control as claimed in claim 2, in which the fourth causal filter is a least squares filter, or a rectangular-means filter, or a first order exponential filter.

15. The method of control as claimed in claim 1, in which one at least of the four filters corresponds to the mean of the results of a least squares filter and of a rectangular-means filter.

16. The method of control as claimed in claim 1, in which the state variable measured may be the pH of the liquid medium, the quantity of biomass, the addition of a basic solution to the liquid medium, and/or the temperature of said liquid medium.

17. A computer program product, intended to be executed in a memory of a processing unit of a computer system, characterized in that it comprises instructions for the implementation of the method as claimed in claim 1 during its execution in the processing unit.
